(19) United States
(12) Patent Application Publication
(10) Pub. No.: US 2005/0235705 A1
(43) Pub. Date: Oct. 27, 2005

(54) Locking device with dual locking mechanisms

(75) Inventors: Renny Tse-Haw Ling, Jhonghe City (TW); Yung-Li Kuo, Jhonghe City (TW)

Correspondence Address: Ladas & Parry, 26 West 61 Street, New York, NY, 10023, US

(73) Assignee: SINOX COMPANY LTD.

(21) Appl. No.: 11/001,620

(22) Filed: Dec. 1, 2004

(30) Foreign Application Priority Data
Apr. 21, 2004 (TW) 093111088

(51) Int. Cl. E05B 37/02

(52) U.S. Cl. 70/25; 70/284; 70/285

(57) ABSTRACT

A locking device with dual locking mechanisms, comprising a lock body and a locking member having two inserting ends. The two inserting ends can engage the lock body separately to form an enclosed loop with the lock body to lock an article. Each of the two inserting ends can be moved respect to the lock body or be disengaged with the lock body to open a gap in the enclosed loop. Two locking mechanisms are disposed inside the lock body and can be operated separately to lock the respective inserting ends, thereby the locking device can be locked or unlocked by operating each of the locking mechanisms.

### BACKGROUND OF THE INVENTION

1. Field of the Invention

The present invention relates to a locking device, such as a padlock or a zipper-lock, with dual locking mechanisms, especially the locking device with two separately operatable locking mechanisms. The locking device can be inter-connected to a locking member or an external locking member to lock an article. The present application claims priority based on ROC (Taiwan) Patent Application No. 093111088 and is related to a contemporaneously filed application also entitled “Locking Device with Dual Locking Mechanisms” with the same assignee and inventors.

2. Description of the Related Art

Lock is a well known product and can be widely used to secure articles with obvious or potential security concerns. For example, a lock can be attached to a luggage case to lock its zipper and to prevent the zipper from being unzipped by any intentional third party.

The operation of locking and unlocking a lock mainly depends on the locking mechanism it contains. Common locking mechanisms include “key locking mechanism,” which is operated by a key and “combination locking mechanism,” in which a lock can be unlocked when a set of combination wheels is rotated and aligned to a correct “password” or locked when the set of combination wheels is rotated and aligned to any incorrect number combination.

For a key locking mechanism, a lock has to be unlocked by a specific key which is not required for a lock with a combination locking mechanism. On the contrary, a lock with a combination locking mechanism can be unlocked when a correct “password” is aligned or locked when an incorrect number combination is produced. In term of operation, each of the both locking mechanisms has a reciprocal advantage for the other, since the key locking mechanisms can safeguard the “password” of the combination locking mechanism from being guessed correctly, while a combination locking mechanism can save the hassle of keeping a key. Therefore, a user can choose a lock with any type of locking mechanism according to his/her needs.

However, in the following scenarios, potential needs for a locking device with multiple locking mechanisms by a user arise, for example:
1. For a locking device with key locking mechanism, a spare key or a new key cut is needed when the key of the locking device is lost.
2. As for the United States, which has been under terrorists' attack, for security reasons, airport security staff will rigorously inspect passengers and their luggage. Sometimes it is necessary for them to open the luggage and make thorough inspection without passengers' consent. For the safety of their belongings, most passengers will secure their luggage by attaching a lock to the zipper of the luggage or use a luggage with a luggage latch. Therefore, when it is necessary for the airport security staff to inspect contents in the luggage, they will have to break the lock and thus cause irreversible damages.

U.S. Pat. No. 6,539,761 (referred to as '761 patent herein) has disclosed a locking device with two different locking mechanisms, which is characterised in that the two locking mechanisms can be operated to engage or disengage a single shackle separately. Compared with conventional locks with only one locking mechanism, it can overcome the above defects when in use.

The '761 patent is characterised in that one end of the shackle comprises “two-step” engaging configuration, in which two locking mechanisms engage the corresponding recesses disposed at one end of the shackle separately, thereby the shackle can be locked to a lock body and form an enclosed loop with the lock body to lock an article, or the shackle can be pulled upwards and thus unlocked to open a gap in the enclosed loop.

However, for the one end of the shackle to be locked by two locking mechanisms separately, the above two-step engaging configuration is required at one end of the shackle. In addition, engaging portions at corresponding positions of the shackle end to be engaged by the two locking mechanisms are necessary. Moreover, the shackle has to be a rigid body so two ends of the shackle can be moved together such that the movement of the free end is consistent with the locked end with respect to the lock body.

From the above, although a locking device with two locking mechanisms has been disclosed, as in the '761 patent, the configuration of two locking mechanisms engaging only one end of the shackle is complicated, and the shackle is limited to a rigid body.

### SUMMARY OF THE INVENTION

It is an object of the present invention to provide a locking device with two locking mechanisms, in which, unlike the '761 patent, two locking mechanisms are engaged with different inserting ends of a locking member separately. In other words, each locking mechanism is locked to the corresponding inserting end of the locking member.

It is the other object of the present invention to provide a locking device with more compact configuration and a locking member which is not limited to a rigid body.

The locking device of the present invention provides the following advantages:
1. Two locking mechanisms are engaged with the corresponding ends of the locking member, which in turn simplifies the configuration between the locking mechanisms and the locking member and provides more flexible overall configuration.
2. The locking member is not limited to a rigid body, since the locking member engage with two locking mechanisms at corresponding ends.

Other objects, advantages and novel features of the present invention will be drawn from the following detailed description of preferred embodiments of the present invention with the accompanying drawings, in which:

### DESCRIPTIONS OF THE DRAWINGS

FIG. 1 illustrates the first preferred embodiment according to the present invention showing the locking device is unlocked;

FIG. 2 illustrates a sectional view of the first embodiment showing the locking device is unlocked at one end;

FIG. 3 illustrates a sectional view of the first embodiment showing the locking device is unlocked at the other end;

FIG. 4 illustrates a sectional view of the first embodiment showing the locking device is unlocked at both ends;

FIG. 5 illustrates the second preferred embodiment according to the present invention;

FIG. 6 illustrates the third preferred embodiment according to the present invention showing the locking device is unlocked;

FIG. 7 illustrates the third embodiment showing the locking device is locked; and

FIG. 8 illustrates the third embodiment showing one end of the locking device is unlocked.

### DETAILED DESCRIPTION OF THE INVENTION

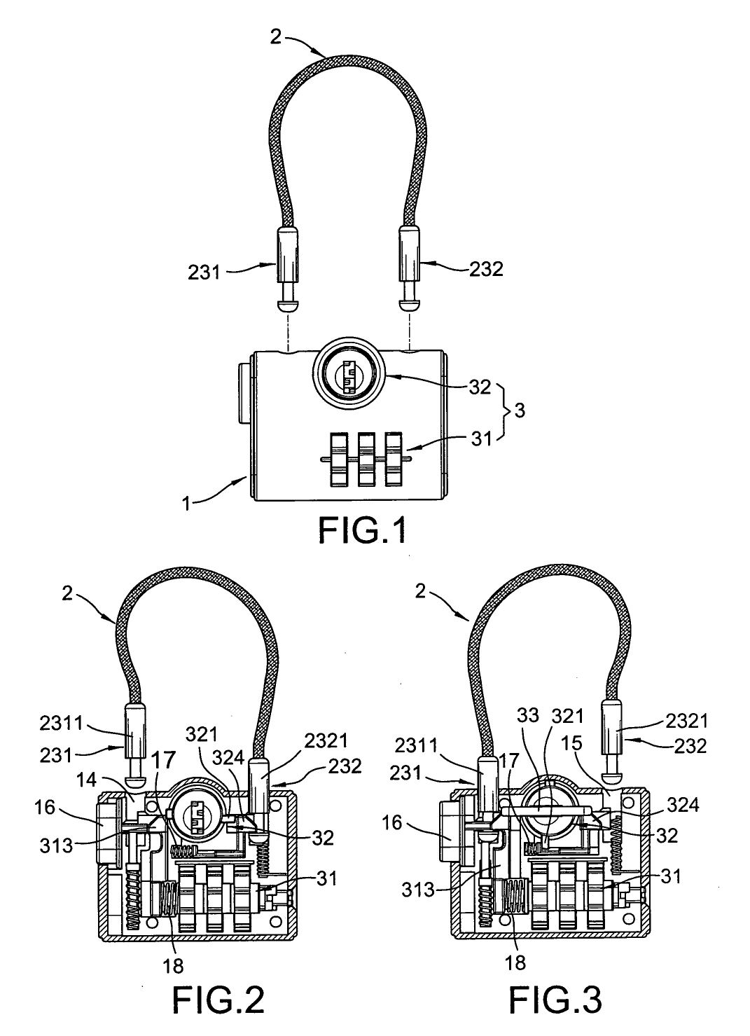

FIGS. 1, 5 and 6 illustrate three embodiments of a locking device according to the present invention. The locking device comprises a lock body 1, 1′, 1″, a locking member 2, 2′, 2″ and locking mechanism set 3, 3′, 3″ disposed in the a lock body 1, 1′, 1″. Locking mechanism set 3, 3′, 3″ further comprises a first locking mechanism 31, 31′, 31″ and a second locking mechanism 32, 32′, 32″.

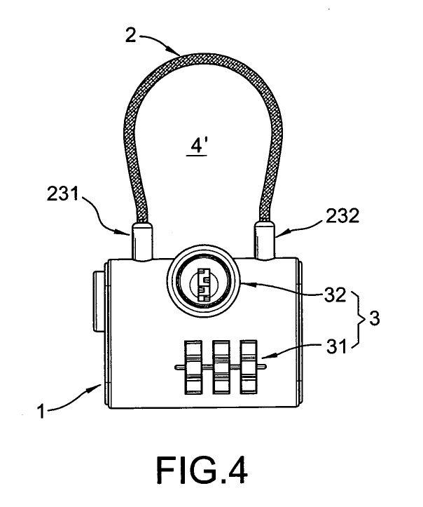

Now referring to FIGS. 1-4, the locking member 2 has a first inserting end 231 and a second inserting end 232. The locking member 2 is bendable and can be locked to the lock body 1 by engaging the first inserting end 231 with the first locking mechanism 31 and the second inserting end 232 with the second locking mechanism 32, thereby the locking member 2 can be maintained at a position where the locking member 2 can form an enclosed loop 4 with the lock body 1. Each of the first and the inserting second ends 231, 232 can be maintained at a position to disengage the lock body 1 separately and open a gap in the enclosed loop 4 while the other of the first and the second inserting ends 231, 232 still engages the lock body 1.

In general, the first and the second locking mechanisms 31, 32 can be different from each other, for example, they can be a combination locking mechanism, a key locking mechanism or any other conventional locking mechanism which can be operated differently. Both of the first and the second locking mechanisms 31, 32 can also be the same, such as a combination locking mechanism or a key locking mechanism. It is noted that locking mechanism set 3 is not necessarily restricted to only combination locking mechanism or key locking mechanism, as long as the first and the second locking mechanisms 31, 32 can be operated to restrict the movement of the first and the second inserting ends 231, 232 of the locking member 2, thereby the locking member 2 can be locked and secured to the lock body 1.

Referring to FIGS. 2 and 3, which illustrate the locking device in an unlocked state from the locking member 2. The locking member 2 can be a continuous cable (such as a steel cable) or a bendable rod. Each of the first and the second inserting ends 231, 232 further comprises an engaging portion 2311, 2321, which can be inserted into a first slot 14 and a second slot 15 of the lock body 1 and engaged with the first and the second locking mechanisms 31, 32, respectively, thereby the first and the second inserting ends 231, 232 are confined to the position to form the enclosed loop 4 with the lock body 1.

As shown in FIGS. 2 and 3, each of the first and the second locking mechanisms 31, 32 further comprises a locking head 313, 324. Each of the locking heads 313, 324 has a locking position to engage the first and the second inserting ends 231, 232, where the movement of the first and the second inserting ends 231, 232 is restricted, and an unlocking position to disengage the first and the second inserting ends 231, 232, where either or both of the first and the second inserting ends 231, 232 can be disengaged from the lock body 1.

As stated above, each of the locking heads 313, 324 can be restricted to a locking position to engage the first and the second inserting ends 231, 232 or be freed to an unlocking position to disengage the first and the second inserting ends 231, 232 by operating the corresponding locking mechanisms 31, 32. Additionally, the engaging portion 2311 can be actuated by one releasing knob 16 to disengage the first inserting end 231. When the first and the second inserting ends 231, 232 are inserted into the first and the second slots 14, 15, locking heads 313, 324 can be maintained at a locking position by a force provided by return springs 17, 18, thus can engage the first and the second inserting ends 231, 232 received in slots 14, 15. On the other hand, when the first locking mechanism 31 is unlocked (i.e. aligned with a correct number combination), the locking head 313 can be pushed towards the first locking mechanism 32 to disengage the first inserting end 231 by pressing the releasing knob 16 (referring to FIG. 2), and the locking head 313 can return to a locking position by the force of the return spring 18 either when the first locking mechanism 31 is locked or when the releasing knob is released (referring to FIG. 3). Similarly, when the second locking mechanism 32 is unlocked by a key 33, a locking tongue 321 disposed at the second mechanism 32 is rotated to an unlocking position such that the locking tongue actuates the locking head 324 to disengage the second inserting ends 232, and the locking head 324 can return to a locking position when the second locking mechanism 32 is locked and the locking tongue 321 is rotated to a locking position such that the locking head 324 is pushed to the locking position by the force of the return spring 17.

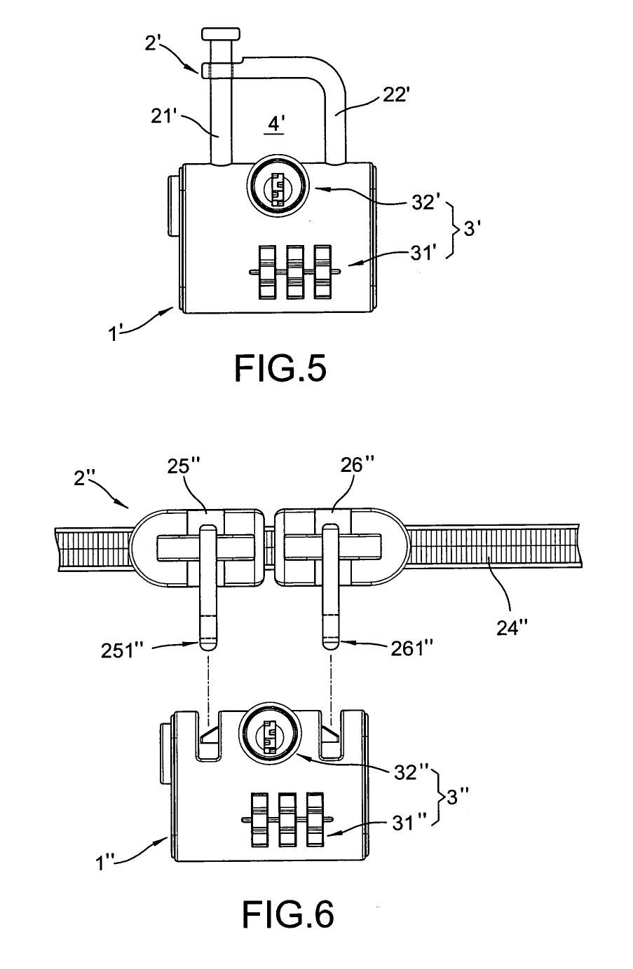

Now referring FIG. 5, which illustrates a varied form of the present invention. The lock body 1′ is engaged with the locking member 2′, which comprises two rods 21′, 22′ inter-lockable to each other. The first and the second inserting ends (not shown in figure) are disposed at one end of the respective rods 21′, 22′ and engage a first and a second locking mechanisms 31′, 32′ in a similar way described above.

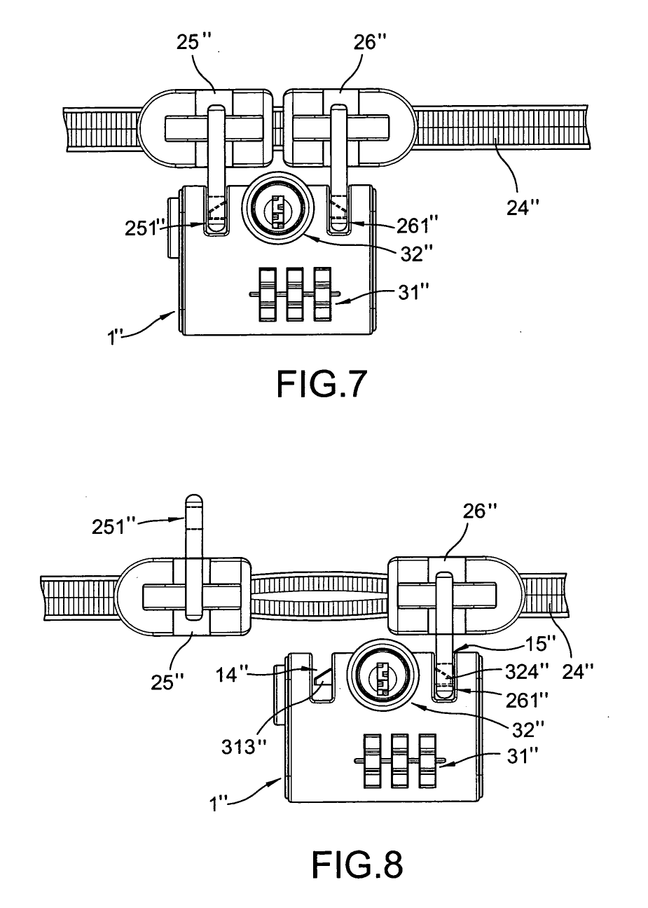

FIGS. 6-8 illustrates another varied form of the present invention. The lock body 1″ is accompanied by the locking member 2″, which in this case is replaced by a zipper 24″ and two sliding members 25″, 26″. The sliding members 25″, 26″ are slidably disposed on the zipper 24″ and can be moved close to or away from each other along the zipper 24″. A first and a second inserting ends 251″, 261″ are disposed on one end of the respective sliding members 25″, 26″, which can engage a first and a second locking mechanisms 31″, 32″ in a similar way described in the first preferred embodiment.

With such configuration, when the zipper 24″ is attached to a luggage or a bag, the sliding members 25″, 26″ can be inserted into through slots 14″, 15″ in the lock body 1″ and separately engage the first and the second locking mechanisms 31″, 32. Similarly, when the movement of locking heads 313″, 324″ are freed, locking heads 313″, 324″ can be actuated to disengage the respective first and the second inserting ends 251″, 261″.

From the above descriptions, it is apparent that the present invention provides a locking device with dual locking mechanisms and has more compact and flexible configuration over the prior art. While the invention has been described in terms of several preferred embodiments, those skilled in the art will recognise that the invention can still be practiced with modifications, within the spirit and scope of the appended claims.

1. A locking device with dual lock mechanisms, comprising:
a lock body, comprising a first slot and a second slot;
a locking member, comprising a first inserting end and a second inserting end, the first and the second inserting ends to be received by the respective first and the second slots and capable of being separately engaged with the lock body and being maintained at a position to form an enclosed loop with the lock body, and each of the first inserting end and the second inserting end capable of being separately disengaged with the lock body, thereby opening a gap in the enclosed loop while the other of the first and the second inserting ends being engaged with the lock body;
a first locking mechanism, operatively disposed in the locking body restricting movement of the first inserting end received in the first slot, thereby maintaining engagement of the first inserting end with the lock body; and
a second locking mechanism, operatively disposed in the locking body restricting movement of the second inserting end received in the second slot, thereby maintaining engagement of the second inserting end with the lock body.

2. The locking device according to claim 1, wherein each of the first and the second inserting ends further comprises an engaging portion to be engaged with the respective first locking mechanism and the second locking mechanism, thereby confining the first and the second inserting ends to the position to form the enclosed loop with the lock body.

3. The locking device according to claim 2, wherein the first and the second inserting ends are unlocked from the first and the second locking mechanism by a releasing knob.

4. The locking device according to claim 2, wherein each of the first and the second locking mechanisms further comprises a locking head, each of the locking heads has a locking position to engage the first and the second inserting ends and an unlocking position to disengage the first and the second inserting ends.

5. The locking device according to claim 1, wherein one of the first and the second locking mechanisms is different from the other.

6. The locking device according to claim 1, wherein both of the first and the second locking mechanisms are the same.

7. The locking device according to claim 1, wherein the locking member is bendable.

8. The locking device according to claim 1, wherein the locking member further comprises two rods inter-lockable to each other, and the first and the second inserting ends are disposed at the respective rods.

9. The locking device according to claim 1, wherein the locking member further comprises a zipper and two sliding members, the sliding members are slidably disposed on the zipper and are capable of being moved close to or away from each other along the zipper, and the first and the second inserting ends are disposed on each of the sliding members.

10. The locking device according to claim 9, wherein each of the first and the second slots is a through slot.

11. The locking device according to claim 9, wherein the locking member is bendable.
